(19) United States
(12) Patent Application Publication
(10) Pub. No.: US 2025/0345734 A1
(43) Pub. Date: Nov. 13, 2025

(54) FILTER ELEMENT COMPRISING AT LEAST TWO FILTER MEDIUM BODIES

(71) Applicant: MANN+HUMMEL GmbH, Ludwigsburg (DE)

(72) Inventors: Pascal NEEF, Trossingen (DE); Christoph WITTMERS, Bietigheim-Bissingen (DE); Andreas WEBER, Freiberg (DE); Dennis STARK, Mauer (DE); Mario RIEGER, Ludwigsburg (DE); Markus HANSELMANN, Lauffen (DE); Peter PEKNY, Neuenmarkt (DE); Eva HALLBAUER, Himmelkron (DE); Daniel SCHMID, Sachsenheim (DE); Steffen GERLACH, Nufringen (DE); Friedrich KUPFER, Marklkofen (DE); Philipp HETTKAMP, Steinheim (DE); Johannes GRAD, Simbach (DE); Pedro Miguel PEREIRA MADEIRA, Bietigheim-Bissingen (DE); Dieter WEISS, Gefrees (DE)

(21) Appl. No.: 19/277,779

(22) Filed: Jul. 23, 2025

Related U.S. Application Data
(63) Continuation of application No. PCT/EP2024/050936, filed on Jan. 16, 2024.

(30) Foreign Application Priority Data
Feb. 7, 2023 (DE) 102023102883.9

(51) Int. Cl. B01D 46/00; B01D 46/24; B01D 46/52; B01D 46/64

(52) U.S. Cl. CPC B01D 46/0036; B01D 46/2411; B01D 46/521; B01D 46/64; B01D 2271/022

(57) ABSTRACT

A filter element for filtering a fluid has two or more axially extending filter medium bodies arranged to be sequentially flowed through radially and including a first and a second filter medium body. The first filter medium body has an outer diameter smaller than an inner diameter of the second filter medium body, is arranged radially inside the second filter medium body, and has a section projecting axially away from the second filter medium body. A casing is arranged at an outer wall surface of the projecting section and extends at least partially circumferentially around the outer wall surface. The casing fluid-impermeably closes at least temporarily the outer wall surface. The first filter medium body is a particle filter and the second filter medium body is an adsorption filter, or vice versa. A filter system is provided with such a filter element for filtering a fluid.

### CROSS-REFERENCE TO RELATED APPLICATIONS

This application is a continuation application of international application No. PCT/EP2024/050936 having an international filing date of Jan. 16, 2024, and designating the United States, the international application claiming a priority date of Feb. 7, 2023, based on prior filed German patent application No. 10 2023 102 883.9, the entire contents of the aforesaid international application and the aforesaid German patent application being incorporated herein by reference.

### BACKGROUND

The invention concerns a filter element, for example an air filter element, for filtering a fluid, for example for filtering air, for a filter system, for example for an air filter system of a fuel cell system or for a cabin air filter system of a motor vehicle, including at least two filter medium bodies as well as a filter system for filtering a fluid, for example for filtering air, for example of a fuel cell system or of a cabin air filter system of a motor vehicle.

Fuel cell systems often require a particle filter and an adsorption filter in order to filter particles as well as harmful gases from the intake air. The filter medium bodies of the various filtration stages have usually different dimensions.

CN212454663U discloses a fuel filter element structure with three-stage filtration including a large filter element for realizing the filtration of the first stage and the second stage and a small filter element for realizing the third stage. The small filter element is mounted inside of the large filter element. A water droplet precipitation space and a water outlet are arranged between the large filter element and the small filter element, and the water outlet communicates with the small filter element. The water outlet is formed at one end of the water droplet precipitation space, an oil outlet is formed at the center of one end of the large filter element and of the small filter element, and the oil outlets communicate with the interiors of the small filter elements.

### SUMMARY

It is an object of the invention to provide a service-friendly and cost-efficient filter element with at least two filter medium bodies for filtering a fluid, for example for filtering air.

A further object is to provide a filter system for such a service-friendly and cost-efficient filter element.

The aforementioned first object is solved according to an aspect of the invention by a filter element for filtering a fluid, for example an air filter element, for a filter system, for example for an air filter system of a fuel cell system or for a cabin air filter system of a motor vehicle, including at least two filter medium bodies each embodied as a hollow cylinder, which extend along an axial direction and each are flowed through in radial direction as well as sequentially by the fluid,
wherein an outer diameter of one of the at least two filter medium bodies is smaller than an inner diameter of the other one of the at least two filter medium bodies,
wherein the one of the at least two filter medium bodies is arranged at least in sections along the axial direction radially inside of the other one of the at least two filter medium bodies and projects away from the latter in relation to the axial direction,
and wherein at an outer wall surface of a section of the one of the at least two filter medium bodies projecting away from the other one of the at least two filter medium bodies, an at least partially circumferentially extending casing is arranged which is configured to fluid-impermeably close the outer wall surface at least temporarily,
and wherein one of the at least two filter medium bodies is configured as a particle filter and another one of the at least two filter medium bodies is embodied as an adsorption filter.

The further object is solved by a filter system for filtering a fluid, for example for filtering air, for example of a fuel cell system or cabin air filter system of a motor vehicle, including a filter housing with a fluid inlet and a fluid outlet and including at least one filter element according to the invention, which is arranged between the fluid inlet and the fluid outlet in the filter housing.

Embodiments and advantages of the invention result from the following description and the accompanying drawings.

According to an aspect of the invention, a filter element for filtering a fluid, for example an air filter element, for a filter system, for example for an air filter system of a fuel cell system or for a cabin air filter system of a motor vehicle is proposed which includes at least two filter medium bodies each embodied as a hollow cylinder, which extend along an axial direction and each are flowed through in radial direction as well as sequentially by the fluid. An outer diameter of one of the at least two filter medium bodies is smaller than an inner diameter of the other one of the at least two filter medium bodies, wherein the one of the at least two filter medium bodies is arranged, at least in sections along the axial direction, radially inside of the other one of the at least two filter medium bodies and axially projects away therefrom. At an outer wall surface of a section of the one of the at least two filter medium bodies, which section projects away from the other one of the at least two filter medium bodies, an at least partially circumferentially extending casing is arranged which is configured to fluid-impermeably close the outer wall surface at least temporarily. One of the at least two filter medium bodies is configured as a particle filter and another one of the at least two filter medium bodies as an adsorption filter.

In embodiments, the one of the filter medium bodies which projects away from the other one of the filter medium bodies may be referred to as inner filter medium body and the other one as outer filter medium body.

The casing closes at least temporarily, but in embodiments also permanently, an outer wall surface of the section of the inner filter medium body which projects away from the outer filter medium body and thus makes it impermeable for the fluid. In this way, it may be ensured that the fluid passes through both filter medium bodies in series so that the outer filter medium body is not bypassed or only bypassed when this is desired. In other words, an accidental bypass that circumvents the outer filter medium body is avoided by means of the casing. Herein, “flowed through sequentially by the fluid” is understood as a serial flow through the filter medium bodies.

In the proposed filter element, both filter medium bodies for the two filtration stages may be arranged in a round filter element, for example. However, an oval filter element is conceivable also. Both filter medium bodies may be arranged concentrically in relation to the axial direction.

The two filter medium bodies may be configured as folded bellows, wound body, loose fill (primarily for adsorption of harmful gases), coated honeycomb body (primarily for adsorption of harmful gases) or as combinations thereof. The height or the width of the bellows of the filter medium bodies may be designed differently. In relation to the cover or bottom of the filter element, the filtration stages may be aligned at one end but also offset at both ends. The taller or wider filter medium body may be arranged radially inwardly as well as radially outwardly. The flow through the filter element may be realized from the interior to the exterior as well as in reverse, wherein the particle filter is always flowed through first. A seal may be arranged radially inwardly as well as positioned outwardly. In this way, a great variability for arranging the two filter medium bodies relative to each other or in the filter element is provided.

According to an embodiment of the filter element, the filter medium body which is flowed through first in the flow direction may be designed as a particle filter. As an alternative or in addition, the downstream filter medium body in the flow direction may be designed as an adsorption filter, for example as an active carbon filter and/or as an ion exchanger. In this manner, first dust and dirt particles may be filtered out of the fluid to be filtered and then harmful gases may be adsorbed in the downstream filter medium body.

According to a further embodiment, the at least two filter medium bodies may be arranged at least in sections at a frame element, wherein at least one region of the frame element which extends between the at least two filter medium bodies is permeable at least in sections so as to be flowed through by the fluid. The fluid-permeable region of the frame element may be for example a component of a central pipe that surrounds the inner filter medium body radially outwardly and is arranged in a cavity provided by the outer filter medium body.

The frame element supports both filter medium bodies relative to each other and absorbs forces which are the result of pressure loss upon flow. Since the frame element between the two filter medium bodies is permeable for flow of the fluid at least in sections, both filter medium bodies may be flowed through sequentially so that first one filtration stage is passed and subsequently the second filtration stage is passed. The available installation space may thus be utilized better. This results in advantages in relation to the adsorption capacity, dust capacity, separation degree, and pressure loss of the filter element.

In embodiments, the casing may be formed by a fluid-impermeable region of the frame element. For example, in this context the fluid-impermeable region of the frame element may adjoin the fluid-permeable region in axial direction. The fluid-permeable region of the frame element and the fluid-impermeable region of the frame element may be for example one piece and, for example, produced by injection molding of plastic material. In embodiments, it may be provided that the fluid-permeable region of the frame element and the fluid-impermeable region of the frame element are formed in a common central pipe that surrounds the inner filter medium body radially outwardly and is arranged in a cavity provided by the outer filter medium body. In a region which is not enclosed by the outer filter medium body, i.e., in the region in which the inner filter medium body projects axially away from the outer filter medium body, the frame element is fluid-impermeable and forms the casing while in a region in which the outer filter medium body surrounds the inner filter medium body, the frame element is fluid-permeable.

In another embodiment, the casing may however also be configured to be separate from the fluid-permeable region of the frame element, for example, in the form of a circumferential sleeve or cap pulled over a section of the inner filter medium body projecting away from the outer filter medium body.

According to an embodiment of the filter element, the at least two filter medium bodies may have a different axial extension. As an alternative or in addition, the at least two filter medium bodies may have a different thickness. The filter medium bodies may thus be designed with different dimensions in relation to their desired filter action.

According to an embodiment of the filter element, one of the at least two filter medium bodies with an axial extension that is larger than the axial extension of the other one of the at least two filter medium bodies may be arranged radially inside or outside of the other one of the at least two filter medium bodies. In this way, depending on the desired flow guiding action in the filter housing, the arrangement of the two filter medium bodies relative to each other may be designed flexibly.

According to an embodiment of the filter element, one of the at least two filter medium bodies with a thickness that is larger than the thickness of the other one of the at least two filter medium bodies may be arranged radially inside or outside of the other one of the at least two filter medium bodies. In this way, the filter medium bodies, depending on the desired filter action and installation space, may be designed differently and, depending on the desired flow guiding action in the filter housing, may also be arranged differently.

According to an embodiment of the filter element, the at least two filter medium bodies may be arranged in alignment in relation to at least one of their two end faces. Alternatively, the at least two filter medium bodies in relation to their two end faces may be arranged so as to be offset at both ends. In this way, the axial position of the two filter medium bodies relative to each other may be designed variably, depending on the installation space which is available.

According to an embodiment of the filter element, the flow direction of the fluid may be oriented outwardly or inwardly in radial direction. The configuration of the filter system may be suitably designed in this way, for example in relation to the flow guiding action of the fluid to be filtered.

According to an embodiment of the filter element, the casing, for example the casing which is formed by the fluid-impermeable region of the frame element, may be connected at least at a first and/or a second end face of the at least two filter medium bodies to an end disc, for example may be embedded in the end disc. As an integral component of the filter element, the casing, for example the casing which is formed by the fluid-impermeable region of the frame element, may thus seal-tightly cover the filter element with at least one end disc at one of the end faces.

According to a further embodiment, the frame element may include an outer sleeve which surrounds an outer wall surface of a radially outer one of the at least two filter medium bodies, wherein for example the outer sleeve of the frame element is configured to be fluid-impermeable and connected to one of the end discs. The outer sleeve may be for example embedded in this context in a material of the end disc. The outer sleeve of the frame element may be embodied separate from the casing. In other embodiments, casing and outer sleeve may also be one piece and produced together by injection molding of plastic material. The outer sleeve may be for example configured so as to be closed circumferentially and/or may completely surround circumferentially the outer filter medium body. The connection of the outer sleeve to the end disc may be for example a fluid-tight connection so that, in other words, the sleeve may be referred to as sealing sleeve.

According to an embodiment of the filter element, the frame element may include at least one seal element which is configured for sealing in axial and/or radial direction between a raw side and a clean side when the filter element is installed as intended in a filter housing of the filter system. For example, in this context the seal element may be arranged radially outside of the at least two filter medium bodies and be configured for sealing between the first housing part and the second housing part of the filter housing of the filter system. In this manner, the sealing action of the filter element as well as of the two housing parts may be realized by one seal element.

According to an embodiment, the seal element may be arranged at the outer sleeve of the frame element and for example may be spaced apart from the end disc in the axial direction. For example, the seal may be present at a free circumferential rim of the outer sleeve which is spaced apart from the end disc. In this way, it is possible to axially space apart the position of the sealing action from the end disc which may have advantages in relation to certain installation space shapes and/or sizes. Furthermore, it is made possible in this way to keep seal pretension forces, which may lead to undesirable deformations, away from the end disc and/or the filter medium body.

According to a further embodiment of the filter element, at least one of the end discs may include an integrated seal element which is configured for sealing in axial and/or radial direction between the raw side and the clean side when the filter element is installed as intended in the filter housing. In this way, the sealing action may be realized after insertion of the filter element in a housing part and closing of the filter housing by placing thereon a second housing part.

According to an embodiment of the filter element, the seal element may be arranged at a radial inner edge or at a radial outer edge of the end disc. In this way, the sealing action of the filter element may be adapted to different installation spaces and/or housing geometries and configurations.

According to an embodiment of the filter element, the first and/or the second filter medium body may be designed as folded filter bellows and/or wound body and/or loose fill and/or coated honeycomb body. Different filter medium bodies may be suitably selected, depending on the boundary conditions of the fluid to be filtered.

According to an embodiment of the filter element, at least one of the two filter medium bodies may be configured as a folded filter bellows. The first and/or the second filter medium body may be designed without an end disc. In this context, end face edges of folds of the at least one of the two filter medium bodies may be sealed between the folds by a seal material at its first and/or second end face. In this manner, the available filter surface area may be enlarged. In other words, a cross-sectional surface area for inflow and/or outflow may be enlarged in this way, which leads to a reduced flow resistance.

According to an embodiment of the filter element, the casing, for example the casing which is formed by the fluid-impermeable region of the frame element, may include at least in sections an at least temporarily open region for at least temporary flow of the fluid therethrough, which may be closed by a switchable cover. Due to the switchable cover, the service life of one of the two filter medium bodies may be prolonged. In this manner, the at least partially open cover of one of the two filter medium bodies, for example, an active carbon bellows, may at least partially be bypassed so that its service life is prolonged. The switchable cover may be controlled as a function of environmental air quality data, for example. Thus, by the switchable cover, depending on the environmental air quality data, the filter stages (particle filtration and harmful gas adsorption) may be optimally utilized. For example, in an operating state with minimal particle load but high harmful gas load (e.g., drive through a city), the particle filter stage may be bypassed by opening the switchable cover. This reduces the flow resistance and thus the energy consumption. In embodiments, this may be realized analogously in case of reverse environmental conditions (high particle load, low harmful gas load).

According to an embodiment of the filter element, the cover may be configured as a switching sleeve rotatable about the axial direction and/or as a switching sleeve slidable in axial direction and/or as a folded bellows movable in axial direction and/or as a roller blind. Different embodiments of the switchable cover, depending on the configuration of the filter medium body, may be selected suitably and controlled by a suitable actor, for example, an electric motor. The actor may be arranged directly at the filter element or at the filter housing. Also conceivable is a control of the cover by vacuum instead of by an electric motor.

According to a further aspect of the invention, a filter system for filtering a fluid, for example for filtering air, for example of a fuel cell system or cabin air filter system of a motor vehicle, is proposed, including a filter housing with a fluid inlet and a fluid outlet and at least one filter element according to the invention which is arranged between the fluid inlet and the fluid outlet in the filter housing.

The proposed filter system may be used for filtering the intake air of a fuel cell system. In this context, the filter element may include at least two filter medium bodies which are flowed through sequentially. For example, the filter medium body which in the flow direction is flowed through first may be configured as a particle filter. As an alternative or in addition, the downstream filter medium body in the flow direction may be configured as an adsorption filter, for example as an active carbon filter and/or as an ion exchanger. In this manner, first dust and dirt particles may be filtered out of the fluid to be filtered and then harmful gases may be adsorbed in the downstream filter medium body. The two filter medium bodies may be arranged concentrically in relation to the axial direction.

### BRIEF DESCRIPTION OF DRAWINGS

Further advantages result from the following drawing description. In the drawings, exemplary embodiments of the invention are illustrated. The drawings and the following detailed description illustrate numerous features in combination. A person of skill in the art will consider the features expediently also individually and combine them to expedient further combinations.

FIG. 1 shows a longitudinal section through a filter system for filtering a fluid, for example for filtering air, for example of a fuel cell system, according to an embodiment of the invention comprising a filter element with two filter medium bodies.

FIG. 2 shows an isometric exploded illustration of the filter element according to FIG. 1.

FIG. 3 shows an isometric exploded illustration of the filter system according to FIG. 1.

FIG. 4 shows a longitudinal section through a filter system including a filter element according to a further embodiment of the invention.

FIG. 5 shows an isometric illustration of the filter element of the filter system according to FIG. 4.

FIG. 6 shows a sectioned plan view of the filter element according to FIG. 5.

FIG. 7 shows a longitudinal section through a filter system including a filter element according to a further embodiment of the invention.

FIG. 8 shows an isometric exploded illustration of the filter element according to FIG. 7.

FIG. 9 shows a longitudinal section through a filter system including a filter element according to a further embodiment of the invention.

FIG. 10 shows an isometric exploded illustration of the filter element according to FIG. 9.

FIG. 11 shows a longitudinal section through a filter system including a filter element according to a further embodiment of the invention.

FIG. 12 shows an isometric exploded illustration of the filter element according to FIG. 11.

FIG. 13 shows an isometric illustration of a filter element according to a further embodiment of the invention including a rotatable switching sleeve as a cover.

FIG. 14 shows the filter element according to FIG. 13 with partially closed cover.

FIG. 15 shows a longitudinal section through the filter element according to FIG. 13.

FIG. 16 shows an isometric illustration of a filter element according to a further embodiment of the invention including an axially slidable switching sleeve as a cover.

FIG. 17 shows the filter element according to FIG. 16 with partially closed cover.

FIG. 18 shows a longitudinal section through the filter element according to FIG. 16.

FIG. 19 shows an isometric illustration of a filter element according to a further embodiment of the invention including a folded bellows as a cover.

FIG. 20 shows the filter element according to FIG. 19 with partially closed cover.

FIG. 21 shows a longitudinal section through the filter element according to FIG. 19.

### DETAILED DESCRIPTION

In the drawing figures, same or same-type components are identified by the same reference characters. The drawing figures show only examples and are not to be understood as limiting.

Directional terminology used in the following with terms such as “left”, “right”, “top”, “bottom”, “in front of”, “behind”, “thereafter” and the like serve only for a better understanding of the drawing figures and is not intended to indicate in any case a limitation of the generality. The illustrated components and elements, their configuration and use may vary in the context of considerations of a person of skill in the art and be adapted to the respective applications.

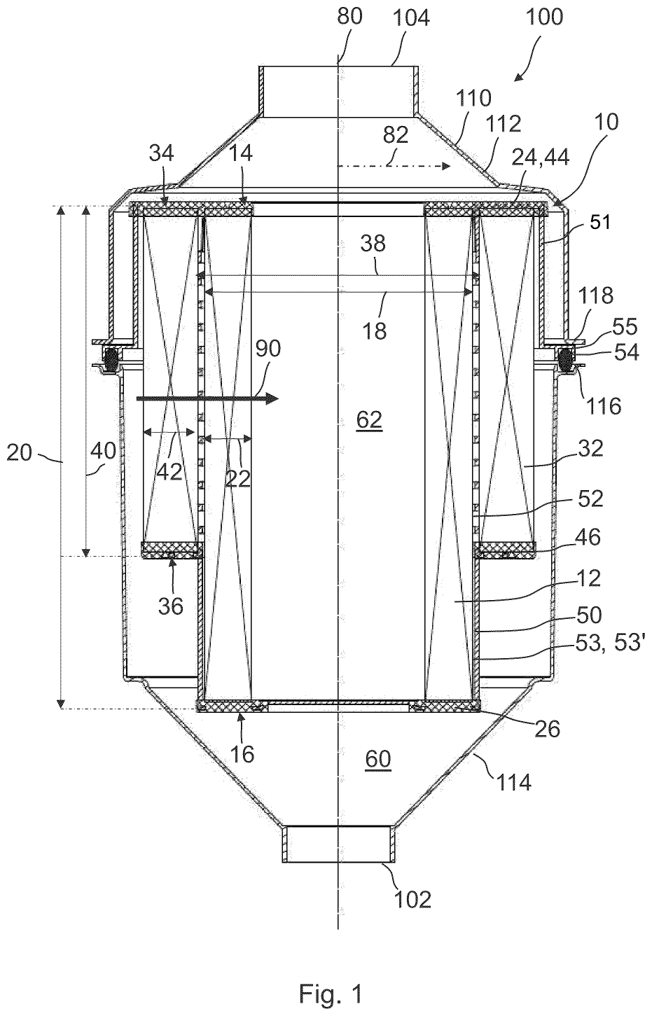

FIG. 1 shows a longitudinal section through a filter system 100 for filtering a fluid, for example for filtering air, for example of a fuel cell system, according to an embodiment of the invention comprising a filter element 10 with two filter medium bodies 12, 32.

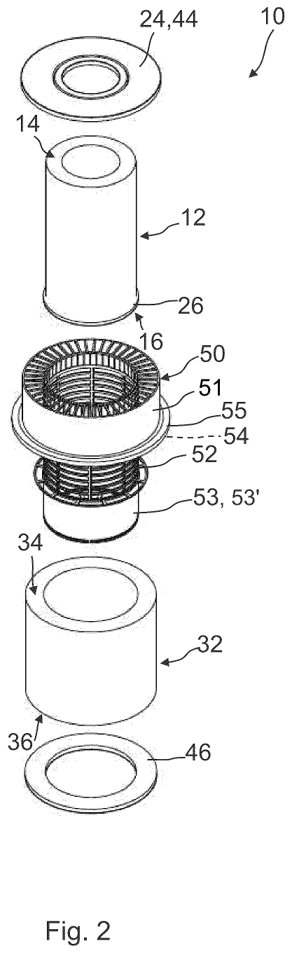

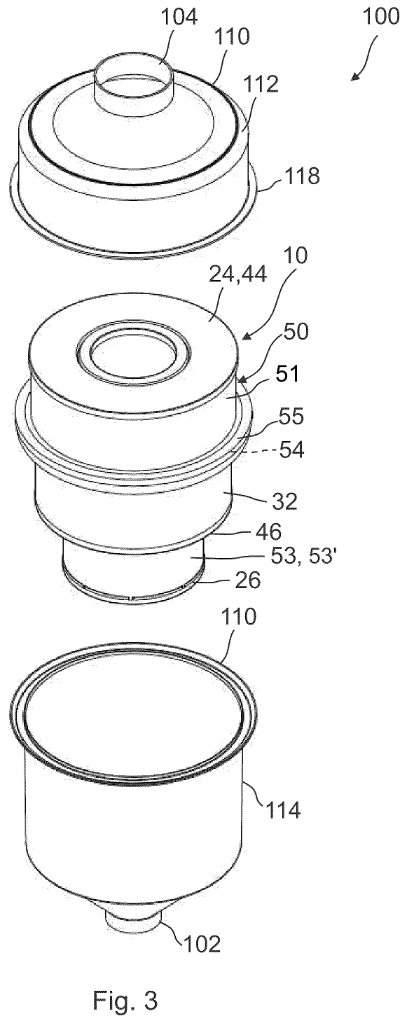

FIG. 2 shows an isometric exploded illustration of the filter element 10 according to FIG. 1, while in FIG. 3 an isometric exploded illustration of the filter system 100 according to FIG. 1 is illustrated.

The filter system 100 comprises a filter housing 110 with a fluid inlet 102 and a fluid outlet 104 in which at least one filter element 10 is arranged between the fluid inlet 102 and the fluid outlet 104.

The filter element 10 comprises two concentric filter medium bodies 12, 32 embodied as hollow cylinders which extend along an axial direction 80 and which, when used as intended, are arranged so as to be flowed through radially and sequentially or serially by the fluid.

An outer diameter 18 of one of the two filter medium bodies 12, 32 is smaller than an inner diameter 38 of the other one of the two filter medium bodies 12, 32. One of the two filter medium bodies 12, 32 is arranged, at least in sections along the axial direction 80, radially inside of the other one of the two filter medium bodies 12, 32. A radially inner one of the filter medium bodies 12 projects axially away from the radially outer one of the filter medium bodies 32.

A frame element 50 is arranged at the filter medium bodies 12, 32 at least in sections. The frame element 50 or support pipe serves for positioning the two filter medium bodies 12, 32 and supports also the filter media of the filter medium bodies 12, 32 relative to each other as well as against the pressure of the flowing fluid.

In this context, at least a region 52 of the frame element 50 which extends between the at least two filter medium bodies 12, 32 is permeable at least in sections so as to be flowed through by the fluid so that the fluid to be filtered may first flow through the one filter medium body 32 and then through the other filter medium body 12.

In the illustrated embodiment, the fluid to be filtered flows through the fluid inlet 102 into the raw side 60 of the filter housing 110 where it may flow in radial direction 90, as indicated by the arrow, through the filter element 10. Thus, first the radially outwardly arranged filter medium body 32 is flowed through. From there, the fluid may flow via the partially permeable region 52 of the frame element 50 through the second filter medium body 12 and reaches in this way the clean region 62. From there, the fluid may exit the filter housing 110 through the fluid outlet 104.

In alternative embodiments, the fluid may flow also through the filter element 10 from the radially inner side to the radially outer side.

In an air filter system of a fuel cell system, the filter medium body 32 which is flowed through first in the flow direction 90 may be designed as a particle filter. The downstream filter medium body 12 in the flow direction 90 may then be configured as an adsorption filter, for example as an active carbon filter and/or as an ion exchanger.

The filter medium bodies 12, 32 may be configured, for example, as a folded filter bellows and/or as a wound body. A filter medium body 12, 32 for adsorption of harmful gases may be embodied as a loose fill and/or as a coated honeycomb body.

The two filter medium bodies 12, 32 may have a different axial extension 20, 40. One of the two filter medium bodies 12 with an axial extension 20 that is larger than the axial extension 40 of the other one of the filter medium bodies 32 is arranged radially inside of the other filter medium body 12, 32. The thickness 42 of the outer filter medium body 32 is somewhat larger than the thickness 22 of the inner filter medium body 12.

In this embodiment, therefore the filter medium body 32 with the larger thickness 42 is arranged radially outside of the other one of the two filter medium bodies 12, 32. As an alternative, it is however also possible that the filter medium body 12, 32 with the larger thickness 22, 42 is arranged radially inside of the other one of the two filter medium bodies 12, 32.

The filter medium bodies 12, 32 are closed at their end faces 14, 16; 34, 36 by the end discs 24, 26; 44, 46, for example, of polyurethane (PUR). Both filter medium bodies 12, 32 are arranged in alignment with the end discs 24, 44 in relation to the first end faces 14, 34. The frame element 50 is thus enclosed at the first end faces 14, 34 of the two filter medium bodies 12, 32 by the end discs 24, 44, for example by form fit.

The frame element 50 comprises an outer sleeve 51 which at least partially surrounds the radially outer filter medium body 32 at its radially outer side and is configured fluid-impermeably. At the outer sleeve 51, a seal element 54 is arranged which is configured for sealing in axial and/or radial direction 80, 82 between the raw side 60 and the clean side 62 when the filter element 10 is installed as intended in the filter housing 110 of the filter system 100. For example, the seal element 54 is arranged radially outside of the two filter medium bodies 12, 32 and seals between the first housing part 112 and the second housing part 114 of the filter housing 110 of the filter system 100. The outer sleeve 51 is for example circumferentially closed and surrounds the outer filter medium body 32 completely in circumferential direction. With its end facing the end disc 24, 44, the outer sleeve 51 is connected to the end disc 24, 44, for example fluid-tightly. The seal element 54, on the other hand, is arranged at an end of the outer sleeve 51 facing away from the end disc 24, 44 or at a free circumferential rim of the outer sleeve 51 and is thus axially spaced apart from the end disc 24, 44.

A section of the inner filter medium body 12 which is not surrounded by the outer filter medium body 32 is covered by a casing 53′. The casing 53′ is arranged at an outer wall surface of the section of the inner filter medium body 12 projecting away from the outer filter medium body 32 and is configured to be fluid-impermeable. In this manner, the fluid is forced to flow first through the outer filter medium body 32 of the filter element 10 prior to it being able to flow through the inner filter medium body 12. In this way, it is ensured that first the particles are filtered out of the fluid by the outer filter medium body 32 prior to the harmful gases being adsorbed in the inner filter medium body 12.

The casing 53′ is formed by a fluid-impermeable region 53 of the frame element 50 wherein the fluid-impermeable region 53 of the frame element 50 in the axial direction 80 adjoins the fluid-permeable region 52. The fluid-permeable region 52 of the frame element 50 and the fluid-impermeable region 53 of the frame element 50 may be one piece and for example are part of a common central pipe, which for example may be an injection-molded plastic part. The common central pipe surrounds the radially inner filter medium body 12 radially outwardly and is arranged in a cavity which is provided by the radially outer filter medium body 32. In a region which is not enclosed by the radially outer filter medium body 32, i.e., in the region in which the radially inner filter medium body 12 projects axially away from the radially outer filter medium body 32, the frame element 50 is fluid-impermeable and forms the casing 53′, while in a region in which the outer filter medium body 32 surrounds the inner filter medium body 12 the frame element 50 is fluid-permeable.

In FIG. 2, the individual components of the filter element 10 are illustrated. Thus, the two filter medium bodies 12, 32 with their end discs 24, 26; 44, 46 may be seen. In this context, the two end discs 24, 44 of the first end faces 14, 34 are formed as a common end disc 24, 44. Furthermore, the structure of the frame element 50 may be seen in which the two filter medium bodies 12, 32 are inserted. Also, fluid-permeable region 52 as well as fluid-impermeable regions 53 of the frame element 50 as well as the outer sleeve 51 may be seen.

FIG. 3 shows the two housing parts 112, 114 of the filter housing 110 as well as the assembled filter element 10 with the radially outwardly arranged seal receptacle 55. The seal element 54 cannot be seen in this illustration because it is arranged in the seal receptacle 55.

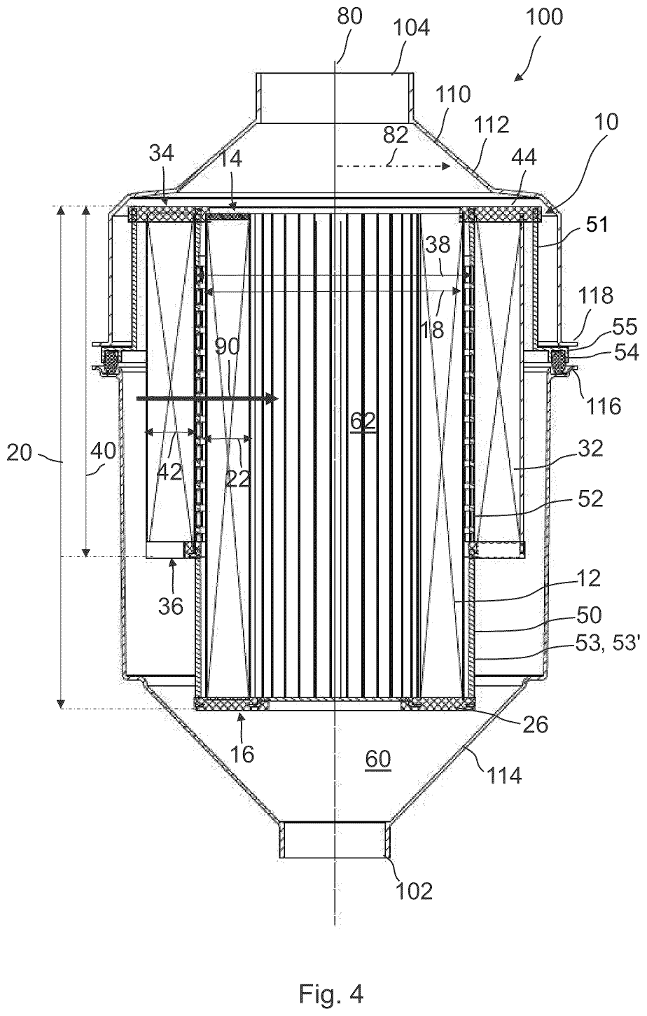

FIGS. 4 to 6 show a further embodiment of the invention.

FIG. 4 shows a longitudinal section through a filter system 100 according to a further embodiment of the invention.

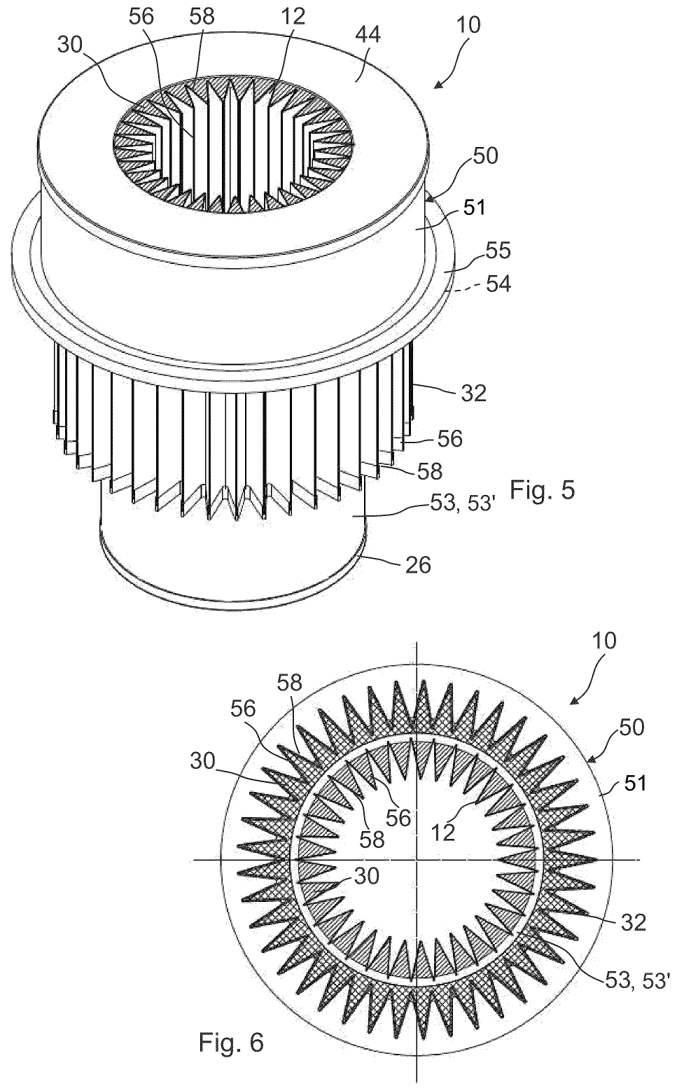

The filter system 100 as well as the filter element 10 is basically very similar as in the embodiment illustrated in FIGS. 1 to 3. The significant difference may be seen in FIG. 5, where an isometric illustration of the filter element 10 is illustrated, and in FIG. 6, where a sectioned plan view of the filter element 10 is illustrated.

The second end face 36 of the outer filter medium body 32 and the first end face 14 of the inner filter medium body 12 are configured without end discs.

The two concentric filter medium bodies 12, 32 are formed as folded filter bellows, respectively. In this context, end face edges 58 of folds 56 of the filter medium bodies 12, 32 are respectively sealed at the first and the second end face 14, 36 between the folds 56 by a seal material 30, for example, glued with a glue bead. In this way, alternatingly open end faces 14, 36 of the filter medium bodies 12, 32 may be suitably sealed by one-sided gluing and/or sealing of the fold end and/or end face edges 58 by means of a glue bead between the folds 56. This increases the free space for the fluid flow between the folds 56.

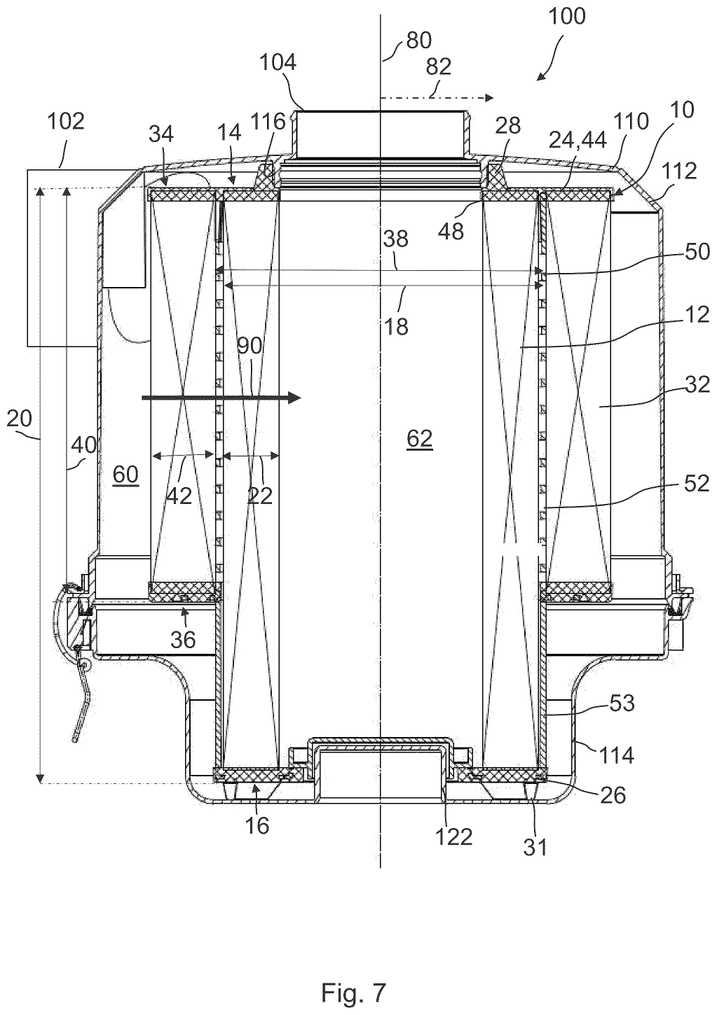

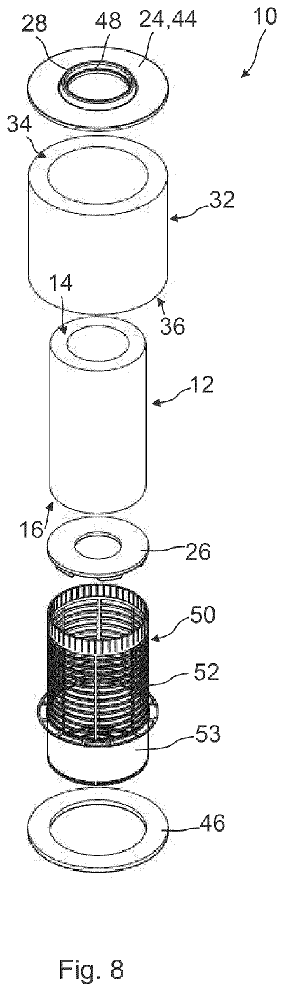

In FIG. 7, a longitudinal section through a filter system according to a further embodiment of the invention is illustrated. FIG. 8 shows in this context an isometric exploded illustration of the filter element 10 according to FIG. 7.

In this embodiment, the fluid inlet 102 is arranged at the first housing part 112 for a tangential inflow at the filter element 10 from a radially outer position. As in the preceding embodiments, the fluid outlet 104 is central in the first housing part 112.

The two filter medium bodies 12, 32 are arranged at the frame element 50 that comprises the casing 53′ in the same manner as in the two preceding embodiments. At the end disc 26 of the inner filter medium body 12 at the second end face, the filter element 10 comprises support elements 31 with which the filter element 10 is supported at the second housing part 114 when the filter housing 110 is closed. In this context, the filter element 10 is arranged also on a centering element 122 of the second housing part 114. The sealing action of the filter element 10 in relation to the filter housing 110 differs however from the two preceding embodiments because it does not comprise an outer sleeve 51. The common end disc 24, 44 of the filter medium bodies 12, 32 at the first end face 14, 34 comprises an integrated seal element 28 which is configured for sealing in axial and/or radial direction 80, 82 between the raw side 60 and the clean side 62 when the filter element 10 is installed as intended in the filter housing 110. The seal element 28 may be seen clearly as a protruding bead in FIG. 8.

The seal element 28 is arranged in this context at a radial inner edge 48 of the end disc 24.

Between the two filter medium bodies 12, 32, the frame element 50 comprises a region 52 which is at least partially permeable for the fluid while the region of the inner filter medium body 12 which is not enclosed by the outer filter medium body 32 is covered by a fluid-impermeable region 53 of the frame element 50 which forms the casing 53′.

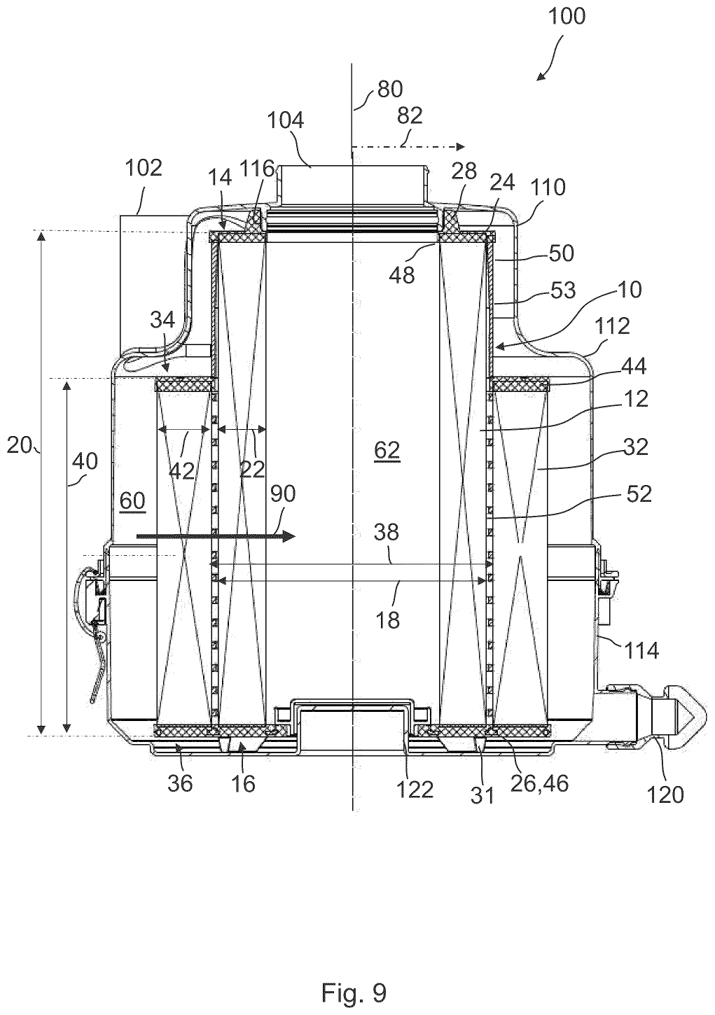

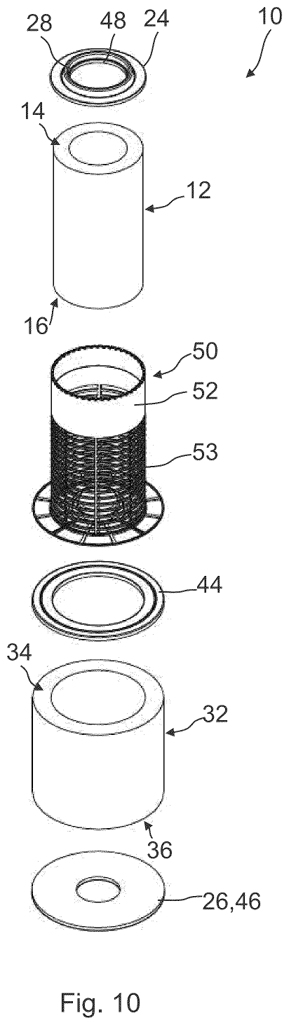

FIG. 9 shows a longitudinal section through a filter system 100 according to a further embodiment of the invention while in FIG. 10 an isometric exploded illustration of the filter element 10 according to FIG. 9 is illustrated.

The filter housing 110 comprises a radial fluid inlet 102 and a central fluid outlet 104 in the first housing part 112. Further, at the second housing part 114 a dirt outlet 120 is arranged by means of which coarse dirt particles collected in the filter housing 110 may be discharged. The flow direction 90 is oriented in radial direction 82 from the exterior to the interior as in the preceding embodiments.

Both filter medium bodies 12, 32 are arranged in alignment at a common end disc 26, 46 in relation to the second end faces 16, 36. The frame element 50 is enclosed at the first end faces 16, 36 of the two filter medium bodies 12, 32 by the end disc 26, 46, for example with form fit.

The common end disc 26, 46 comprises support elements 31 for support at the second housing part 114 when the filter housing 110 is closed.

At its radial inner edge 48, the end disc 24 of the inner filter medium body 12 comprises a seal element 28 which is oriented in axial direction 80 for sealing between raw side 60 and clean side 62 of the filter system 100.

Between the two filter medium bodies 12, 32, the frame element 50 comprises a region 52 which is at least partially fluid-permeable for the fluid while the region of the inner filter medium body 12 which is not enclosed by the outer filter medium body 32 is covered by a fluid-impermeable region 53 of the frame element 50 and which forms the casing 53′.

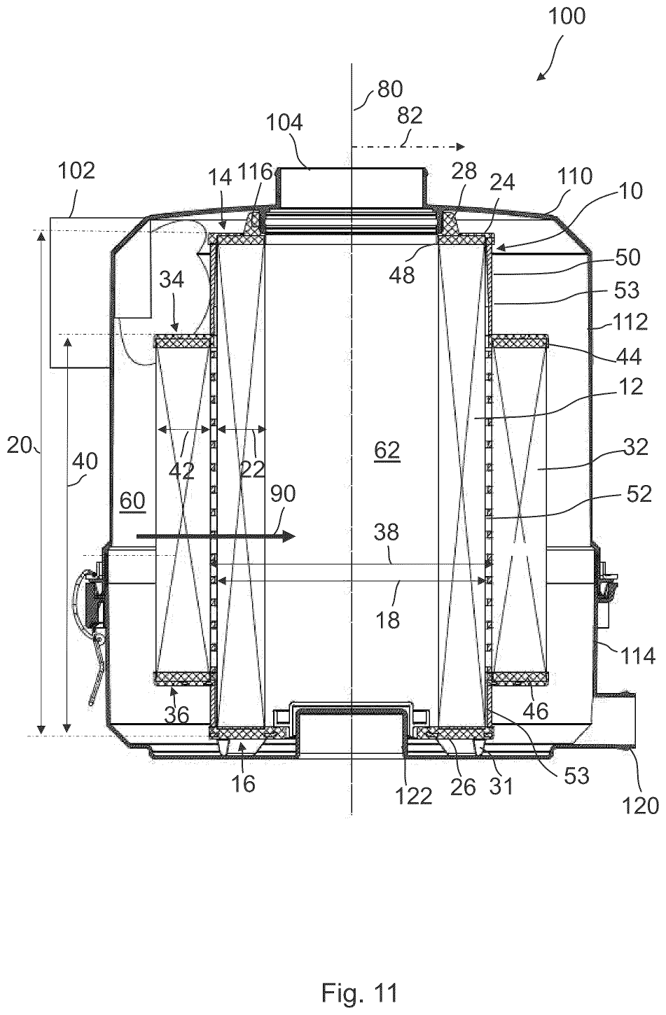

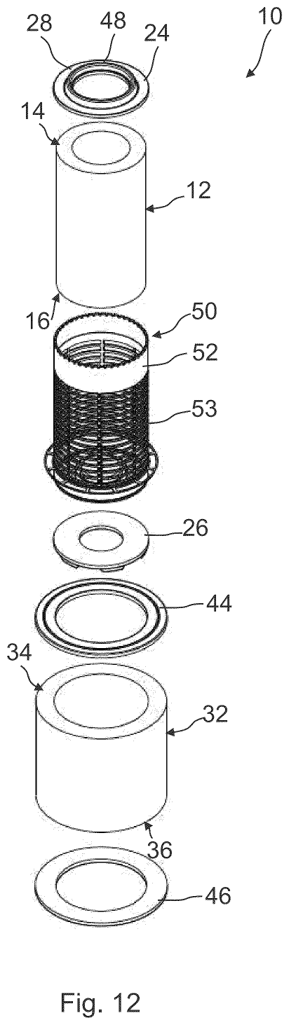

FIG. 11 shows a longitudinal section through a filter system 100 according to a further embodiment of the invention while in FIG. 12 an isometric exploded illustration of the filter element 10 according to FIG. 11 is illustrated.

In this embodiment, which is similar in regard to the fluid inlet 102 and fluid outlet 104 to the embodiment illustrated in FIG. 9, the two filter medium bodies 12, 32 are offset in relation to the two end faces 14, 16; 34, 36 at both ends.

The fluid flow as well as sealing between raw side 60 and clean side 62 is embodied as in the embodiment in FIG. 9. The end discs 24, 26; 44, 46 of the two filter medium bodies 12, 32 are each separately configured.

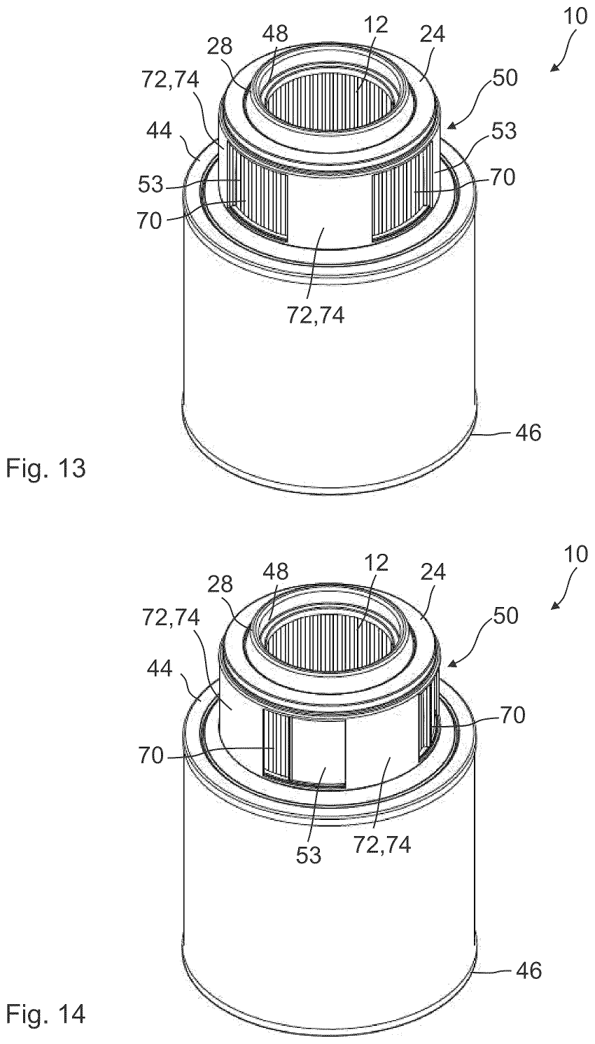

FIG. 13 shows an isometric illustration of a filter element 10 according to a further embodiment of the invention, wherein the casing 53′ at least in sections comprises an at least temporarily open region 70 for at least temporary flow of the fluid which may be closed by a switchable cover 72. The cover 72 is configured as a switching sleeve 74 which is rotatable around the axial direction 80.

Due to the different axial extension 20, 40 of the two filter medium bodies 12, 32, a switchable cover 72 may be arranged within the stepped configuration of the two filter medium bodies 12, 32 with the goal of prolonging the service life of the high-performance inner filter medium body 12, for example, of the active carbon bellows. The active carbon bellows may be bypassed at least partially when the cover 72 is closed.

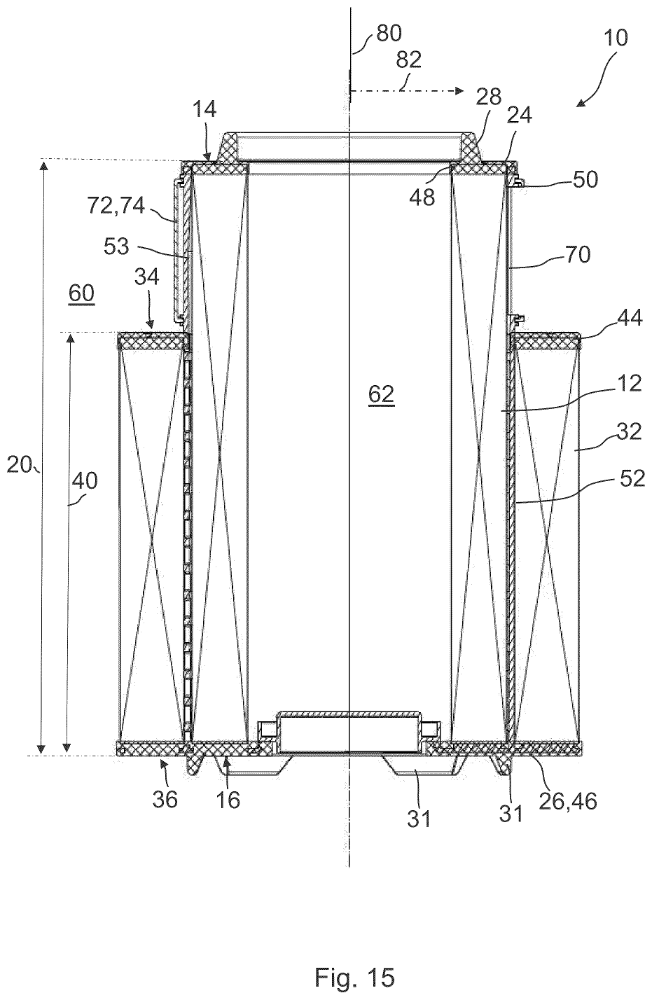

In this embodiment, an actually fluid-impermeable region 53 of the frame element 50 comprises at least in sections an at least partially open region 70 for at least temporary flow of the fluid therethrough which is closeable by the switchable cover 72. Due to the open region 70, the fluid, upon flow in radial direction 82 (see FIG. 15) from the exterior to the interior, may circumvent in a bypass the outer filter medium body 32 and thus directly flow through a region of the inner filter medium body 12.

In this manner, the service life of the high-performance inner filter medium body 12, for example, an active carbon bellows, may be prolonged because, for a minimal harmful gas load in the environment, the open region 70 may be released by the rotatable switching sleeve 74 while the open region 70 may be closed by the switching sleeve 74 at high harmful gas load in the environment.

In principle, the filter stages (particle filtration and harmful gas adsorption) may be optimally utilized due to the switchable cover 72 which is switchable as a function of environmental air quality data.

FIG. 14 shows in this context the filter element according to FIG. 13 with partially closed cover 72. The switching sleeve 74 is rotated here such that the cover 72 covers partially the open region 70. In this manner, the size of the open region 70 may be adapted to the level of harmful gas load or particle load.

In FIG. 15, a longitudinal section through the filter element according to FIG. 13 is illustrated. In section, a portion of the fluid-impermeable region 53 at the outer side of the inner filter medium body 12 may be seen which, in the illustrated position, is covered by the cover 72 of the rotatable switching sleeve 74 resting thereon. At the opposed side of the filter medium body 12, an open region 70 may be seen.

Due to the different axial extension 20, 40 of the two filter medium bodies 12, 32, a switchable cover 72 may be arranged within the stepped configuration of the two filter medium bodies 12, 32 with the goal of prolonging the service life of the high-performance inner filter medium body 12, for example, of the active carbon bellows.

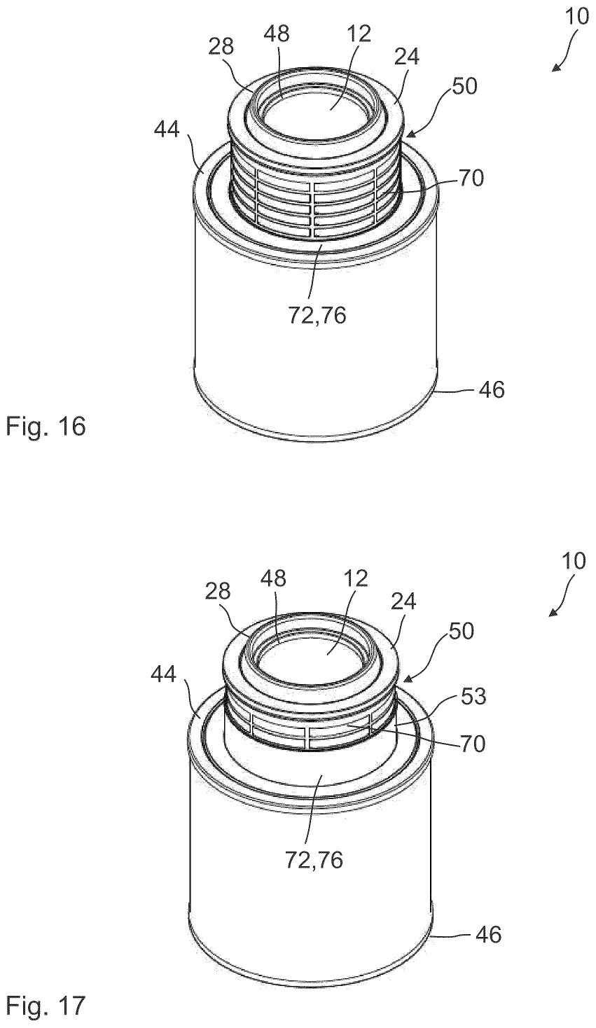

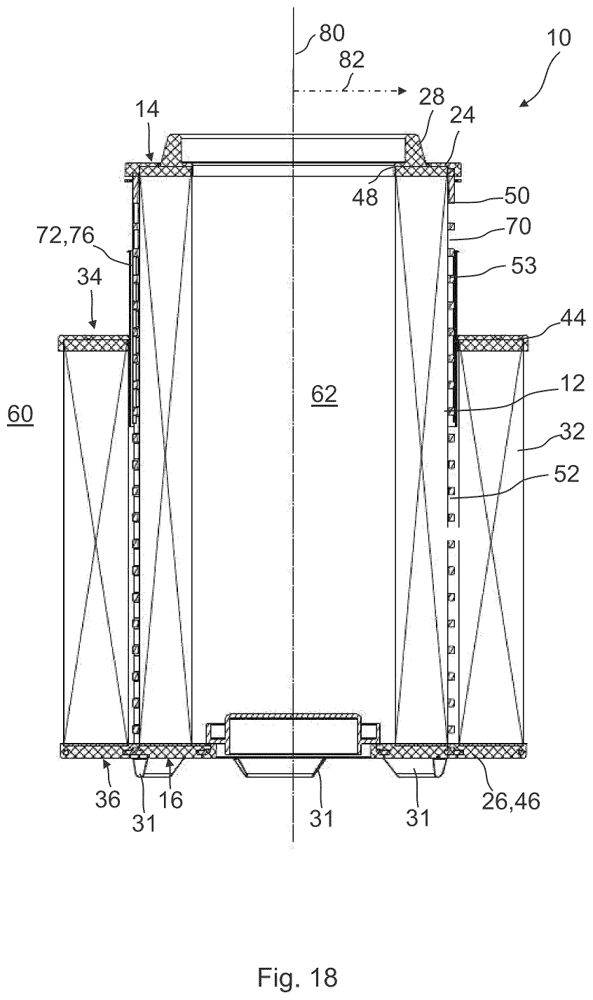

FIG. 16 shows an isometric illustration of a filter element 10 according to a further embodiment of the invention with a switching sleeve 76 which is slidable in the axial direction 80 as a cover 72. FIG. 17 shows the filter element 10 with partially closed cover 72 while in FIG. 18 a longitudinal section through the filter element 10 with partially closed cover 72 is illustrated.

In this embodiment, the cover 72 is configured as a switching sleeve 76 slidable in the axial direction 80 which, for complete release of the open region 70, may be pushed back between the two filter medium bodies 12, 32 so that the part of the inner filter medium body 12, which projects past the outer filter medium body 32 in axial direction 80, may be released completely for flow of the fluid therethrough. Depending on the harmful gas load, for example, the axially slidable switching sleeve 76 may cover a more or less large portion of the open region 70 and may limit the flow of the fluid therethrough in this way.

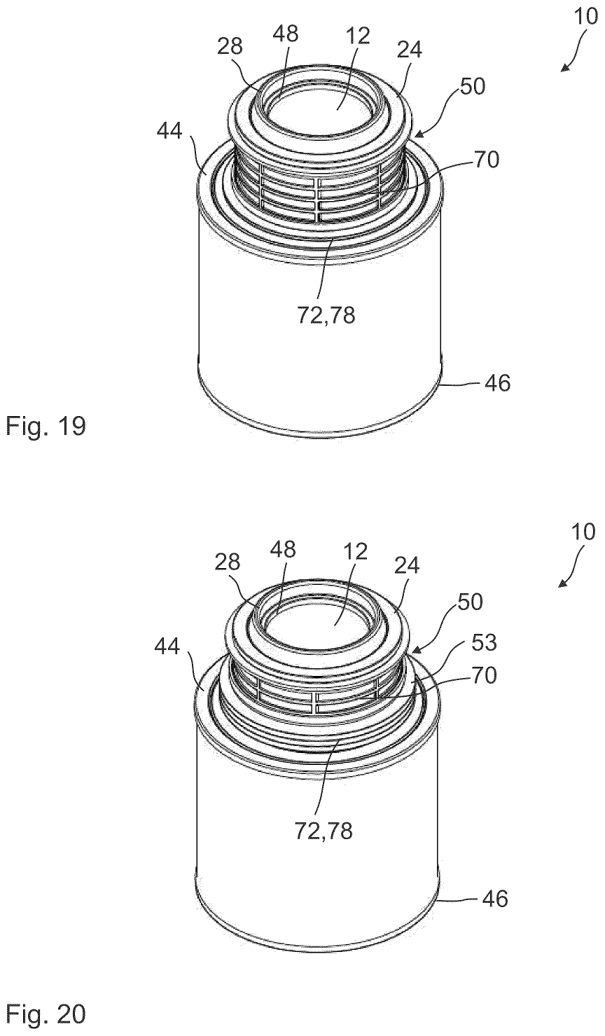

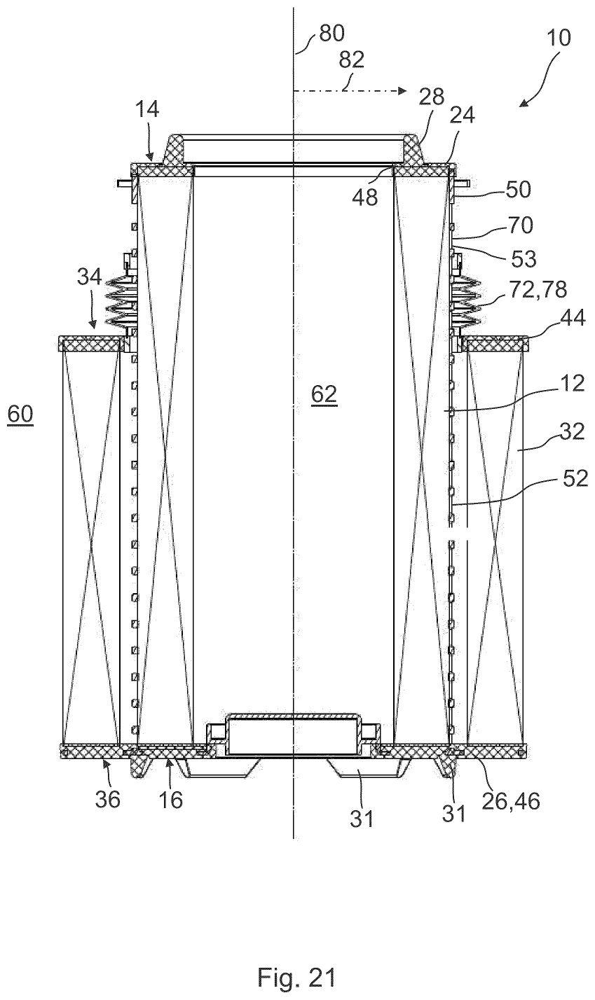

FIG. 19 shows an isometric illustration of a filter element 10 according to a further embodiment of the invention comprising a folded bellows 78 as a cover 72. FIG. 20 shows the filter element 10 with partially closed cover 72 while in FIG. 21 a longitudinal section through the filter element 10 is illustrated.

In this embodiment, the cover 72 is configured as a folded bellows 78 which is movable in axial direction 80 and which may be pulled along the portion of the inner filter medium body 12 projecting past the outer filter medium body 32 and in this way may release a more or less large open region 70 for flow of the fluid therethrough. In case of complete release of the open region 70, the folded bellows 78 is resting on the end disc 44 at the first end face 34 of the outer filter medium body 32.

### REFERENCE CHARACTERS

10 filter element
12 filter medium body
14 first end face
16 second end face
18 outer diameter
20 axial extension
22 thickness
24 end disc
26 end disc
28 seal element
30 seal material
31 support element
32 filter medium body
34 first end face
36 second end face
38 inner diameter
40 axial extension
42 thickness
44 end disc
46 end disc
48 radial inner edge
50 frame element
51 outer sleeve
52 fluid-permeable region
53 casing
53 fluid-impermeable region
54 seal element
55 seal receptacle
56 fold
58 end face edge
60 raw side
62 clean side
70 opening
72 switchable cover
74 switching sleeve/rotatable sleeve
76 switching sleeve/slidable sleeve
78 folded bellows
80 axial direction
82 radial direction
90 flow direction
100 filter system
102 fluid inlet
104 fluid outlet
110 filter housing
112 first housing part
114 second housing part
120 dirt outlet
122 centering element

What is claimed is:

1. A filter element for filtering a fluid, the filter element comprising:
two or more filter medium bodies each configured as a hollow cylinder and extending along an axial direction of the filter element, wherein the two or more filter medium bodies are arranged to be flowed through by the fluid sequentially in a radial direction;
wherein the two or more filter medium bodies include a first filter medium body and a second filter medium body, wherein the first filter medium body comprises an outer diameter that is smaller than an inner diameter of the second filter medium body;
wherein the first filter medium body is arranged, at least in sections along the axial direction, radially inside of the second filter medium body and comprises a section projecting axially away from the second filter medium body in the axial direction;
wherein a casing is arranged at an outer wall surface of the section projecting axially away from the second filter medium body and extends at least partially circumferentially around the outer wall surface of the section projecting axially away from the second filter medium body, wherein the casing is configured to fluid-impermeably close at least temporarily the outer wall surface of the section projecting axially away from the second filter medium body;
wherein the first filter medium body is a particle filter and the second filter medium body is an adsorption filter, or wherein the first filter medium body is an adsorption filter and the second filter medium body is a particle filter.

2. The filter element according to claim 1, wherein the particle filter is flowed through first by the fluid.

3. The filter element according to claim 1, wherein the adsorption filter is an active carbon filter and/or an ion exchanger.

4. The filter element according to claim 1, further comprising a frame element arranged at least in sections at the first filter medium body and at the second filter medium body, wherein the frame element comprises at least one region extending between the first filter medium body and the second filter medium body, wherein the at least one region is permeable at least in sections for flow of the fluid therethrough.

5. The filter element according to claim 4, wherein the casing is formed by a fluid-impermeable region of the frame element.

6. The filter element according to claim 5, wherein the fluid-impermeable region of the frame element adjoins in the axial direction the at least one region that is permeable at least in sections for flow of the fluid therethrough.

7. The filter element according to claim 4, wherein the frame element comprises an outer sleeve surrounding an outer wall surface of the second filter medium body, and wherein the outer sleeve of the frame element is fluid-impermeable and is connected to an end disc of the second filter medium body.

8. The filter element according to claim 7, wherein the frame element comprises at least one seal element configured to seal in the axial direction and/or in the radial direction between a raw side and a clean side of the filter element when the filter element is installed in a filter housing of a filter system.

9. The filter element according to claim 8, wherein the at least one seal element is arranged radially outside of the second filter medium body and is configured to seal between a first housing part and a second housing part of the filter housing of the filter system.

10. The filter element according to claim 8, wherein the at least one seal element is arranged at the outer sleeve of the frame element surrounding the outer wall surface of the second filter medium body, wherein the at least one seal element is spaced apart from the end disc of the second filter medium body in the axial direction.

11. The filter element according to claim 1, wherein the first filter medium body comprises an axial extension and the second filter medium body comprises an axial extension and the axial extension of the first filter medium body differs from the axial extension of the second filter medium body, and/or wherein the first filter medium body comprises a thickness and the second filter medium body comprises a thickness and the thickness of the first filter medium body differs from the thickness of the second filter medium body.

12. The filter element according to claim 1, wherein the first filter medium body comprises an end face and the second filter medium body comprises an end face, wherein the end face of the first filter medium body and the end face of the second filter medium body are aligned.

13. The filter element according to claim 1, wherein the first filter medium body comprises opposed end faces and the second filter medium body comprises opposed end faces, wherein the first filter medium body and the second filter medium body are arranged such that the opposed end faces of the first filter medium body are offset in relation to the opposed end faces of the second filter medium body.

14. The filter element according to claim 1, wherein the casing is connected at least to a first end disc at a first end face and/or to a second end disc at a second end face of the first filter medium body and of the second filter medium body, respectively.

15. The filter element according to claim 1, wherein the first filter medium body and/or the second filter medium body is selected from the group consisting of a folded filter bellows, a wound body, a loose fill, and a coated honeycomb body.

16. The filter element according to claim 1, wherein at least one of the first filter medium body and the second filter medium body is a folded filter bellows and is configured without end discs, wherein end face edges of folds of the folded filter bellows are sealed between the folds by a seal material at a first end face and/or at a second end face of the at least one of the first filter medium body and the second filter medium body.

17. The filter element according to claim 1, wherein the casing comprises at least in sections an at least temporarily open region enabling at least a temporary flow of the fluid therethrough, and wherein a switchable cover is arranged at the casing and is configured to close the at least temporarily open region.

18. The filter element according to claim 17, further comprising a frame element arranged at least in sections at the first filter medium body and at the second filter medium body, wherein the frame element comprises a fluid-impermeable region and the casing is formed by the fluid-impermeable region of the frame element.

19. The filter element according to claim 17, wherein the switchable cover is one or more covers selected from the group consisting of a switching sleeve rotatable around the axial direction, a switching sleeve slidable in the axial direction, and a folded bellows movable in the axial direction.

20. A filter system for filtering a fluid, the filter system comprising:
a filter housing comprising a fluid inlet and a fluid outlet; and
at least one filter element according to claim 1 arranged between the fluid inlet and the fluid outlet in the filter housing.
